(19) United States
(12) Patent Application Publication
(10) Pub. No.: US 2026/0368434 A1
(43) Pub. Date: Nov. 19, 2026

(54) SYSTEM FOR MODELLING SEMANTICS OF VAGUE TEMPORAL EXPRESSIONS

(71) Applicant: Honda Motor Co., Ltd., Tokyo (JP)

(72) Inventors: Julian Eggert, Offenbach/Main (DE); Joerg Deigmoeller, Offenbach/Main (DE); Philipp Cimiano, Bielefeld (DE); Svenja Kenneweg, Bielefeld (DE)

(73) Assignee: Honda Motor Co., Ltd., Tokyo (JP)

(21) Appl. No.: 19/208,571

(22) Filed: May 14, 2025

(51) Int. Cl. G06F 40/30; G06F 16/3329; G06F 40/279

(52) U.S. Cl. CPC G06F 40/30; G06F 16/3329; G06F 40/279

(57) ABSTRACT

A system and a method for mapping temporal expressions to quantitative time expressions are provided. The system includes: a memory, a processor configured to store information and to retrieve information from the memory, and an input interface configured to acquire textual information, where the textual information includes at least one vague temporal expression. The processor is configured to determine a context in the acquired textual information, to respectively map the at least one temporal expression to at least one quantitative time expression based on the determined context. The system includes an output interface configured to output the at least one quantitative time expression. A system and a method for mapping quantitative time expressions to temporal expressions, especially vague temporal expressions, are also provided.

### TECHNICAL FIELD

The disclosure relates to systems, methods, and computer programs in the technical field of language processing, language understanding, and language translation. In particular, the disclosure proposes a system for understanding temporal expressions, especially vague temporal expressions, to provide quantitative time expressions facilitating human-machine interaction and enabling temporal searches in data memories. The disclosure includes methods and systems for providing temporal expressions, especially vague temporal expressions, for quantitative time expressions.

### BACKGROUND

A personal assistance system providing support to a person with cognitive impairment monitors and memorizes the actions, which the assisted person is performing over an extended period. The assisted person may request the assistance system to provide an answer to a question, for example, to the question of the assisted person “Did I take my pills recently?”. In order to provide an answer to the question, the assistance system has to interpret the question, for instance, with regard to the vague temporal adverbial “recently” in the example, which describes a temporal distance between the past event of the assisted person taking pills and the utterance time, when the assisted person poses the question. The question itself, as posed by the assisted person, fails to specify exactly the temporal range, for which the assistance system will have to search its memory for occurrences of the assisted person taking their pills. Hence, in order to assist the person, the assistance system requires the capability to interpret the vague temporal adverbial “recently” in the example, in order to search its memory successfully and to provide a correct factual basis for composing a correct answer to the question. Similar considerations may of course apply to different questions.

### SUMMARY

In view of the above, it is an objective to enhance the capabilities of assistance systems to interpret and understand temporal expressions in human speech, especially vague temporal expressions.

A system for mapping temporal expressions to quantitative time expressions, a method, and a computer program, as described in the corresponding independent claims, provide advantageous solutions to the aforementioned problem.

The dependent claims define further exemplary but advantageous embodiments.

The system for mapping temporal expressions to quantitative time expressions comprises a memory, a processor configured to store information and to retrieve information from the memory, and an input interface configured to acquire textual information, wherein the textual information includes at least one temporal expression. The processor is configured to determine a context in the acquired textual information, and to respectively map the at least one temporal expression to at least one quantitative time expression based on the determined context. The system comprises an output interface configured to output the at least one quantitative time expression.

A system for mapping quantitative time expressions to temporal expressions comprises a memory, a processor configured to store information and to retrieve information from the memory, and an input interface configured to acquire textual information, wherein the textual information includes at least one quantitative time expression. The processor is configured to determine a context in the acquired textual information, to respectively map the at least one quantitative time expression to at least one temporal expression based on the determined context. The system comprises an output interface configured to output the one temporal expression.

The system for mapping quantitative time expressions to temporal expressions may have exemplary embodiments, which correspond to the exemplary embodiments of the system for mapping temporal expressions to quantitative time expressions, as described above.

In exemplary embodiments of the system, the processor is configured to map the quantitative time expression to the respective at least one at least one temporal expression by representing semantics of the at least one temporal expression in probabilistic distributions combining the semantics with event-specific properties. The processor may map the at least one quantitative time expression to the respective at least one temporal expression by using factorization and Gaussian distribution for modelling a context sensitive interpretation of the at least one temporal expression.

The system for mapping quantitative time expressions to temporal expressions provides technical systems with a capability of understanding temporal expressions, especially vague temporal expressions, facilitating human-machine interaction by provide temporal expressions that correspond semantically to quantitative time expressions. A method for mapping temporal expressions to quantitative time expressions, in a system comprising a memory and a processor for storing information in and retrieving information from the memory comprises steps of acquiring, by an input interface, textual information, wherein the textual information includes at least one temporal expression, determining, by the processor, a context in the acquired textual information, mapping, by the processor, the at least one temporal expression to at least one quantitative time expression based on the determined context, and outputting, by an output interface, the at least one quantitative time expression.

The method for mapping temporal expressions to quantitative time expressions achieves corresponding advantageous effects as discussed with reference to the system for mapping temporal expressions to quantitative time expressions. The method may have exemplary embodiments, which correspond to the exemplary embodiments of the system, as described above.

A method for mapping quantitative time expressions to temporal expressions in a system comprising a memory and a processor for storing information in and retrieving information from the memory, comprises steps of: acquiring, by an input interface, textual information, wherein the textual information includes at least one quantitative time expression; determining, by the processor, a context in the acquired textual information; mapping, by the processor, the at least one quantitative time expression to at least one temporal expression based on the determined context; and outputting, by an output interface, the at least one temporal expression.

The method for mapping quantitative time expressions to temporal expressions achieves corresponding advantageous effects as discussed with reference to the system for mapping temporal expressions to quantitative time expressions. The method may have exemplary embodiments, which correspond to the exemplary embodiments of the system, as described above. A non-transitory computer-readable medium storing a computer program comprising instructions, which, when a processor executes the computer program is executed by a processor, causes the processor to perform the method of an embodiment.

### BRIEF DESCRIPTION OF THE DRAWINGS

The following description of embodiments refers to the figures.

FIG. 1 shows a simplified flowchart illustrating processing steps of the computer-implemented method.

FIG. 2 provides an overview over the functional architecture of a system according to an exemplary embodiment.

FIG. 3 presents a simplified overview of a hardware architecture for an implementation of an exemplary embodiment.

FIG. 4 shows a simplified flowchart illustrating processing steps of the computer-implemented method.

FIG. 5 shows a block diagram illustrating structural and functional blocks of a system for mapping vague temporal expressions to quantitative time expressions.

In the figures, corresponding elements have the same reference signs. The discussion of the figures avoids discussion of same reference signs in different figures wherever considered possible without adversely affecting comprehensibility and avoiding unnecessary repetitions for sake of conciseness.

### DETAILED DESCRIPTION OF EMBODIMENTS

In the below provided detailed explanation, some aspects known in the art are explained briefly only in order to avoid overloading the description of the present invention. However, for some of these aspects reference is made to publications providing a more detailed insight. The respective reference list is attached at the end of the description.

Before discussing embodiments with reference to the figures, some general aspects of the disclosed approach are introduced.

Temporal expressions, in particular vague temporal expressions or vague temporal adverbials (short: temporal adverbials), e.g. “recently”, “just”, “some time ago”, or “long time ago” are used to describe a temporal distance between an event that occurred in the past and the utterance time of a statement that includes the temporal adverbial. In present context, the term temporal expression may include temporal adverbials, temporal adverbials as a type of a single word adverb, or temporal adverbials of a type that comprises plural words, e.g. temporal phrases or temporal clauses. The temporal adverbials are vague insofar that they do not specify a specific length of the temporal interval passed between the cited event and the utterance time, leaving the length of the interval insufficiently specified. Insufficiently specified means in this context that the literal wording leaves room for interpretation, is ambiguous, and could be interpreted in different ways. Nevertheless, the length of the temporal interval is not arbitrary, as corroborated by the following examples:

Regarding the statement in the sentence “I just celebrated my birthday” when the event of the birthday or the birthday celebration was a few days ago, such statement would not be uttered when the birthday was months or even years ago.

Another example refers to the sentence “I just brushed my teeth”, which may be uttered when the event of the speaker brushing the teeth is minutes, but not days or weeks, ago.

Both examples use the same vague temporal expression “just”. However, a length of the respective temporal intervals between time of the events and the time of the utterance of the statements differ between both examples, ranging from a few minutes in the second example to several days in the first example. The length is shaped not only by the choice of the temporal expression, but also by the type of event included in the statement. For example, there are two variables of an event that affect the length, they can refer to: a duration of the event and a frequency of the event.

The disclosed compositional approach to modeling the semantics of vague temporal expressions uses a modeling of the semantics of vague temporal expressions that is compositional, capturing not only how the expressions define a temporal frame of reference but also how different types of events shape the interpretation of the vague temporal expressions.

Generally, semantics of vague expressions can be viewed as having crisp yet uncertain boundaries. The disclosed approach represents the vague temporal expressions and the corresponding events as probabilistic distributions, enabling to assign higher probabilities to those time points that are most likely to be described by a given vague temporal expression and a corresponding event. Alleging that each vague temporal expression, e.g. the adverbial “just”, has not only one specific (distinct) meaning for each type of event, the approach factorizes the interpretation: the meaning of an adverbial distribution remains fixed, and the properties of the event shape how that distribution is applied. Thus, the disclosed compositional model relies on two types of probability density functions P_{Adv} and P_{Ev}.

When applied to an event that has happened t times units ago in the past, P_{Ev}(t) transforms the distance between now and the time t into a distribution specific for the event type Ev that represents the probability that an event of the type Ev that took place t time units ago can actually be said to have happened before now.

The probability density function P_{Adv} includes the result of the transformation by P_{Ev} so that a distribution P_{Adv}(P_{Ev}(t)) models a probability that the vague temporal expression Adv can be suitably used to describe an event of type Ev that happened t time units ago.

The disclosure uses the factorized compositional model to capture the meaning of vague temporal expressions. In the following description, the term vague temporal expression is used synonymously with vague temporal adverbial or abbreviated with the term adverbial.

Regarding the example mentioned in the background, the person with the cognitive impairment can be supported by an intelligent assistance system that memorizes the actions the assisted person is performing over the day. This assistance system may be implemented by the system of claim 1, which has the capability to map the (vague) temporal expression “recently” of the exemplary question to a quantitative time expression, which includes a specific time range based on the context of the event “taking pills”. The system may then check if an action like “taking pills” appears in the memory within the period defined by the specific time range.

The system proposed in this disclosure thus enhances the capabilities of assistance systems to interpret and understand temporal expressions in human speech, especially vague temporal expressions.

Vague temporal expressions, including adverbials such as “recently” and “just”, or temporal expressions such as “some time ago” and “long time ago”, describe the temporal distance between the past event and the utterance time of the speech content including the vague temporal expression, but leave the exact duration under-specified. The interpretation of the vague temporal expressions may be influenced by characteristics of the event, e.g., a duration and a frequency of occurrence of the event. The system proposed in this disclosure provides a framework for using, for example, a compositional, cognitive model to represent the semantics of the vague temporal expression as probabilistic distributions, combining the meanings of the temporal expressions with event-specific characteristics. The presented approach avoids assigning event-specific meanings to adverbials and offers the possibility of instead using factorization and Gaussian distributions to model the context-sensitive interpretations of vague temporal expressions.

In cognitive science, vague adverbial expressions have been studied presently within the context of spatial concepts only. The temporal domain, however, remains largely unexplored, even though linguistics and semantics have attempted theoretical descriptions of temporal concepts. Large Language Models (LLMs), such as GPT-4, encode these concepts in a manner that is implicit and only loosely defined, relying solely on patterns derived from observed data. The system according to the present disclosure aims at explicitly formalizing such concepts, bridging the gap between the implicit representations in LLMs and a numerical characterization of time periods.

Known approaches for interpreting relative and abbreviated date and time expressions included in the text of emails, as for example disclosed in patent application JP 2004-303141 A use date and time information extracted from quoted emails, as well as extracted transmission date and time from a header part of emails for replacing relative time expressions and omitted time and date expressions in the e-mail with a converted absolute time and date expressions. The known approach requires a document storage means for storing e-mails sent and received in the past, for extraction from quoted e-mails of stored in the document storage means. Contrary thereto, the exemplary embodiment relies on context, e.g. including at least one of a duration and a frequency of an event, in the acquired textual information, and does not need to rely on a document storage means for storing e-mails sent and received in the past, and offers a more versatile approach during application.

The approach presented in patent application JP 2020-064396 A uses a conversion table to convert an ambiguous keyword such as “before this” included in the utterance of a user into specific information, e.g. into an absolute time. Conversion values of the conversion table may change dynamically, e.g., dynamically with time, and can be set for each user. The conversion table may include items that the user may freely change, such as the period for “before” and “the other day”. Contrary thereto, the exemplary embodiment relies on the context, in particular on an event recited in the acquired textual information, and therefore offers the advantage of a situation and context-adaptive interpretation of temporal expressions that are vague and ambiguous. The exemplary embodiment does not rely on person-related and potentially sensitive information stored in a conversion table and the extensive databases as the the prior art.

U.S. Pat. No. 11,900,061 B2 discloses an approach for predicting an intended time interval for a content segment that includes temporal expressions by decoding the content segment into a program that describes the temporal logic of the content segment, accessing contextual data associated with the temporal expressions, evaluating the program using the accessed contextual data for predicting the intended time interval for the content segment. The approach focuses in particular on interpreting complex temporal expressions e.g. that include interrelated temporal expressions within the content segment describing the intent of the user. The prior art represents the intent of the user uttered in the content segment in a program, enabling the developer to inspect the predicted program, and generating natural language for complex temporal relationships included in the content segment. Contrary thereto, exemplary embodiments provide a compositional cognitive model, which represents semantics of the temporal expressions as probabilistic distributions combining their meanings with event-specific properties. Instead of assigning event-specific meanings to the temporal expressions, the exemplary embodiments rely on factorization and Gaussian distributions to model context-sensitive interpretations, which enables advantageous applications of the trained model in terms of processing time and resources.

According to an exemplary embodiment of the system, the processor is configured to determine the context including at least one of a duration and a frequency of an event in the acquired textual information.

The textual information that includes the temporal expression includes further information that enables to interpret the temporal expression. In particular, events described in the textual information, and including time related-information such as a frequency of occurrence of the described event enable the system to map the temporal expression to the quantitative time expression that enables a meaningful search in a database, for example.

In an exemplary embodiment, the system comprises the processor configured to determine the context including a personal state of a user in the acquired textual information.

The personal state of the user may include at least one of a stressed state and a relaxed state.

The personal state of the user may include meaningful information that enables to interpret the temporal expression for a mapping to the quantitative time expression.

The processor of an exemplary embodiment of the system is configured to determine the context including a cultural framing of a user.

In a process of cultural framing, an individual user and groups of users are shaped how to understand and interpret events, issues, and experiences based on the respective cultural background and perceived context of the events, issues, and experiences.

The cultural background of a human includes meaningful information that enables to interpret the vague temporal expression in a manner that enables the mapping to the quantitative time expression with a high degree of reliability.

In an exemplary embodiment of the system, the quantitative time expression includes at least one of an absolute time and an absolute date.

Quantitative time expressions, e.g. a date, an hour of the day, enable a meaningful search in a database for specific events relevant to a query of the human user.

In an exemplary embodiment of the system, the at least one time expression comprises a temporal adverbial, including in particular one of the vague temporal adverbials “recently”, “just”, “some time ago”, “long time ago”.

The recited vague and, e.g., relative temporal expressions regularly fail to specify a precise timing that enables a machine to search for specific events in a database. Thus, the proposed system improves the known approaches for interpreting human speech significantly. The term “temporal expression” denotes in particular temporal adverbials such as “recently”, “just”, “some time ago”, “long time ago” that have a vague temporal meaning. Temporal adverbials describe the temporal distance between a past event and the utterance time but leave the exact duration of the temporal distance unspecified or at least insufficiently specified.

The processor of an exemplary embodiment of the system is configured to map the at least one temporal expression to the respective at least one quantitative time expression by representing semantics of the at least one temporal expression in probabilistic distributions by combining the semantics with event-specific properties using a compositional cognitive model.

The compositional cognitive model may be a factorized model that captures the semantics of the vague temporal expressions as probabilistic distributions. The probabilistic distributions may be composed with event-specific distributions, in order to yield a contextualized meaning for the temporal expression applied to a specific event. Parameters of the compositional model may be fitted using existing data, thereby capturing judgements of native speakers regarding the applicability of the temporal expressions to events that occurred some predetermined time ago. When comparing the use of the compositional cognitive model with an approach that uses a non-factorized model based on a single Gaussian distribution for each pair of event and temporal adverbial, both models may yield similar predictive power, however, the compositional cognitive model of the disclosed approach is simpler, e.g. resulting in an increased computational efficiency, and has a better extendibility.

In an exemplary embodiment of the system, the processor is configured to map the at least one temporal expression to the respective at least one quantitative time expression by using a factorization and a Gaussian distribution for modelling a context sensitive interpretation of the at least one temporal expression.

By using factorization and Gaussian distributions for modelling the context sensitive interpretation of the at least one temporal expression, the exemplary embodiment avoids assigning event-specific meanings to the temporal expressions. Thus, a generic processing with a wide applicability is provided, without requiring numerous steps of a detailed semantic analysis and computationally expensive processing.

According to an exemplary embodiment of the system, the input interface is configured to acquire information on actions performed by a user, wherein the acquired textual information including the at least one vague temporal expression is related to the actions. The processor is further configured to determine, based on the at least one quantitative time expression and the acquired information on the actions a response to the acquired textual information.

The information on actions performed by the user includes, for example, a time on the actions performed by the user. By applying the exemplary embodiment, an advantageous assistance system implementing the method may, for example, support a person with cognitive impairment by memorizes the actions the person is performing over an extended period of time, e.g., a day. The person may ask the assistance system, whether the person did take her or his pills recently. The exemplary embodiment has the capability to map the temporal expression “recently” to a time period representing the quantitative time expression, which is characteristic for the assisted person taking its pills. Then, the assistance system determines if the action “taking the pills” is included in the acquired information on actions performed by the assisted person and stored in the memory for the time period, and outputs a suitable response to the assisted person. This application illustrates the advantageous human-machine interface for supporting the assisted person, which the exemplary embodiment provides. The assisted person having a cognitive impairment is not burdened with the requirement of providing a precise definition of the time period, but may even use fuzzy temporal expressions in the communication with the assistance system, without being presented with imprecise and unsatisfactory results. The acceptance of the assistance system will be increased.

The disclosed approach of using compositional factorized models is advantageous for modeling the semantics of the temporal expressions, capturing how the temporal expressions define a temporal frame of reference, and how different types of events shape a resulting interpretation of the vague temporal expression in the specific context.

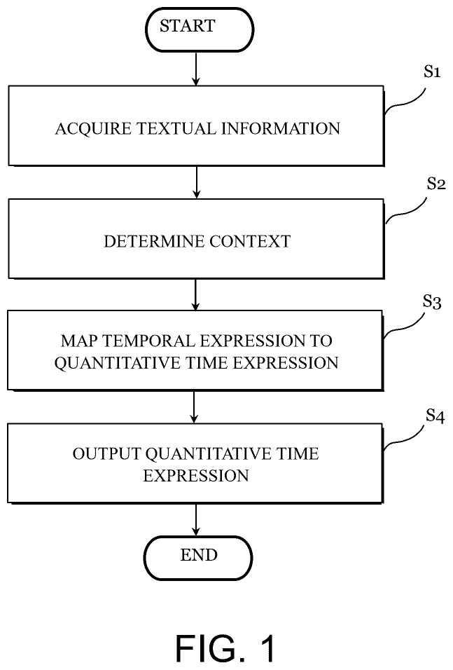

FIG. 1 shows a simplified flowchart illustrating processing steps of the computer-implemented method. The method for mapping vague temporal expressions to quantitative time expressions in a system 1 comprising a memory 2 and a processor 3 storing information in and retrieving information from the memory 2.

The method comprises a step S1 of an input interface 4 acquiring textual information, wherein the textual information includes at least one temporal expression.

The at least one temporal expression comprises a vague temporal adverbial, including in particular one of “recently”, “just”, “some time ago”, and “long time ago”.

The method comprises a step S2 of the processor 2 determining a context in the acquired textual information.

In particular, the processor 3 determines the context including an event in the acquired textual information, wherein the determined context includes at least one of a duration of the event and a frequency of the event.

The context may include a personal state of a user in the acquired textual information. The context may include a cultural framing of a user.

The method comprises a step S3 of the processor mapping the at least one vague temporal expression to at least one quantitative time expression based on the determined context.

The quantitative time expression may include at least one of an absolute time and an absolute date.

In particular, the processor 3 maps the at least one temporal expression to the respective at least one quantitative time expression by representing semantics of the at least one temporal expression in probabilistic distributions combining the semantics with event-specific properties using a compositional cognitive model.

In particular, the processor 3 maps the at least one temporal expression to the respective at least one quantitative time expression using factorization and Gaussian distribution for modelling a context sensitive interpretation of the at least one vague temporal expression.

The model used for the mapping of step S3 is a factorized model, representing a complex predicate that is modeled via the meaning of its parts and how they are composed together. In the disclosed framework, the parts comprise the temporal expression on the one hand and the type of event as a reference class on the other hand.

For modeling the complex compositional meaning of a temporal expression and an event, there are at least three important parts to consider:

First, each temporal expression, e.g. “just”, “recently”, “long time ago”, conveys a distinct notion of temporal proximity and has a distinct meaning.

Second, events can be classified into different types of events based on their characteristic temporal signature, determined by factors such as their duration and frequency

Third, a number t of time units that have passed since the specific event happened until the time of utterance at the current point in time (“now”).

The application of a particular temporal adverbial Adv to an event of type Ev that occurred t time units ago to have crisp but unknown boundaries. An uncertainty in the boundaries is modeled using probability theory, and propose a factorized probabilistic model that relies on two probability density functions: P_{Adv} and P_{Ev}. P_{Adv} is specific for each adverbial Adv and P_{Ev} is specific for each type of event Ev.

The factorized model, which returns the probability that the temporal expression Adv applies to an event of type Ev that happened t time units ago, is given by expression (1):

P_{Adv}(P_{Ev}(t)) (1)

Expression (1) describes a factorized model, which returns the probability that the temporal expression Adv applies to an event of type Ev that happened t time units ago. In (1) P_{Adv} denotes the probability density function of temporal expression Adv, an expression-specific function. P_{Ev} denotes the probability density function of event type Ev, hence an event-specific function. The parameter t denotes a time unit.

The (probability) function P_{Ev} models the probability that an event of type Ev that happened t time units before now can actually be said to have happened before now. Considering an example of an event, e.g., the teeth brushing event: a teeth brushing event that occurred a few minutes ago has from a probabilistic point of view happened before now, while a teeth brushing event that occurred a few milliseconds ago did less clearly happen before now. The probabilistic distribution P_{Ev} thus captures the temporal signature of events of type Ev with respect to the likelihood that a user considers to describe instances of the event type Ev as having happened before depending on how long ago the instances of the event type Ev actually happened. The event type specific probability distribution models the reference class, as different types of events will generally have a different signature of the function. The function models the uncertainty in describing that one event of type Ev occurs before another time point or interval.

Assuming that there is some uncertainty for each event in terms of when it took place exactly, events are modeled as Gaussian distributions as illustrated in expression (2):

$$\frac{1}{\sqrt{2 {πσ}^{2}}} exp ( - \frac{1}{2} \frac{{( x - μ )}^{2}}{{σ}^{2}} ) ; \qquad ( 2 )$$

An uncertainty related to whether an event of the type Ev took place before another event or time interval can also be modeled as a Gaussian distribution as indicated in expression (3), in which erf denotes the Gauss error function:

$$\frac{1}{2} ( erf ( \frac{μ}{\sqrt{2} σ} ) + 1 ) ; \qquad ( 3 )$$

Expression (3) defines an uncertainty that an event of type Ev took place before another event or time interval t, using the Gauss error function erf. The parameter μ denotes the number t of time units that have passed since the specific event occurred, and the parameter σ is a parameter that varies depending on the type of event. In particular, the parameter σ influences the function of (3) to output higher probabilities for time units t that are closer to or farther away from the utterance time.

Thus, the function P_{Ev} is modeled as a Gaussian distribution of the type of event, in which u represents the number t of time units that have passed since the specific event occurred.

The second function of the model of expression (1) is the adverbial-specific function P_{Adv}, which takes the normalized value as input. One might model each adverbial as a Gaussian distribution around its prototype. Thus, the adverbial-specific function P_{Adv} is expressed in (4) as:

$${P}_{Adv} = exp ( - \frac{1}{2} {( \frac{( x - {μ}_{a} )}{{σ}_{a}} )}^{2} ) ; \qquad ( 4 )$$

In (4), the parameter μₐ denotes a mean of the Gaussian distribution, defined individually for each temporal expression. The parameter σₐ denotes a standard deviation of the Gaussian distribution, defined individually for each temporal expression.

The function shown in (4) has the two parameters μₐ and σₐ, defined individually for each vague temporal expression. Thus, the event-specific function P_{Ev} feeds into a normalized Gaussian distribution with specific parameters for each vague temporal expression. Expression (4) yields a probability representing how likely it is that a human speaker would use a certain temporal expression, given the underlying probability that an event indeed occurred before another event.

The parameters of the model may be fitted using data from a previous study disclosed by Kenneweg, S., Jackson, B. B., Deigmoeller, J., Eggert, J., & Cimiano, P. (2024 May): An empirical study on vague deictic temporal adverbials. In: Proceedings of the workshop on cognitive aspects of the lexicon @ lrec-coling 2024 (pp. 26-31). Torino, Italia: ELRA and ICCL: [Kenneweg et al., 2024] that elicited judgements of native speakers regarding the applicability of a vague temporal expression to an event of a specific type that occurred t time units ago. The study collected probabilities reflecting the likelihood of a specific vague temporal expression for a given event and elapsed time since the event occurred. The participants of the study, which had the cultural framing of adult native English speakers, rated the applicability of a vague temporal expression applied in English sentences to a past event on a Likert scale. An exemplary sentence from the survey is: “Tom's Birthday was 1 day ago. Statement: Tom had his birthday recently.” The study comprised six types of events that include “brushing teeth”, “birthday”, “vacation”, “sabbatical”, “year abroad”, and “marriage”. The study further included four vague temporal expressions including “just”, “recently”, “some time ago”, and “long time ago”.

For each pair of an event and a vague temporal expression, the authors explored the applicability across seven elapsed times at which the event occurred. They divided the survey into six separate questionnaires, each targeting one event applied to all vague temporal expression. One hundred participants recruited via an online platform completed each questionnaire.

Using the study, and in order to fit the parameters of the disclosed model, the published Likert-scale responses were normalized into an interval [0,1]. This results in 16.800 data points, resulting from six events multiplied with four vague temporal expressions, further multiplied with seven times 100 votes. Given the compositional nature of the disclosed model, the combined function P_{Adv} (P_{Ev}(t)) is solved for each pair of an event and a temporal expression, and over all data point, resulting in determining the best parameters for a temporal expression over all evaluated events.

For instance, for the event “vacation”, the approach for model fitting involves solving equations like

P_{Just}(_{PVacation}(1Month))=0.2; (6)

For evaluating the equations, time values are standardized by converting them to minutes, with 1 Month corresponding to 43800 minutes, based on an average month length of 30.4 days. For the fitting of the model parameters, a least-squares optimization is used for minimizing the residuals, e.g., a difference between observed probabilities and modeled probabilities.

The model-fitting provides the optimal parameters for means and standard deviation for each vague temporal expression-specific function P_{Adv}, as well as the standard deviation for each event-specific function P_{Ev} for all 4 fitted temporal expressions and six events. The resulting final standard deviations for each event-specific function P_{Ev} are shown in table 1:

TABLE 1

| Event | σₐ |
|---|---|
| Brushing Teeth | 935 |
| Birthday | 314830 |
| Vacation | 396579 |
| Sabbatical | 798494 |
| Year Abroad | 1240803 |
| Marriage | 2334869 |

The means and standard deviations for the Gaussian distributions of each temporal expression-specific function P_{Adv} are presented in table 2:

TABLE 2

| Adverbial | σₐ | μₐ |
|---|---|---|
| Just | 0.04 | 0.48 |
| Recently | 0.09 | 0.45 |
| Some Time Ago | 0.19 | 0.78 |
| Long Time Ago | 0.23 | 1.00 |

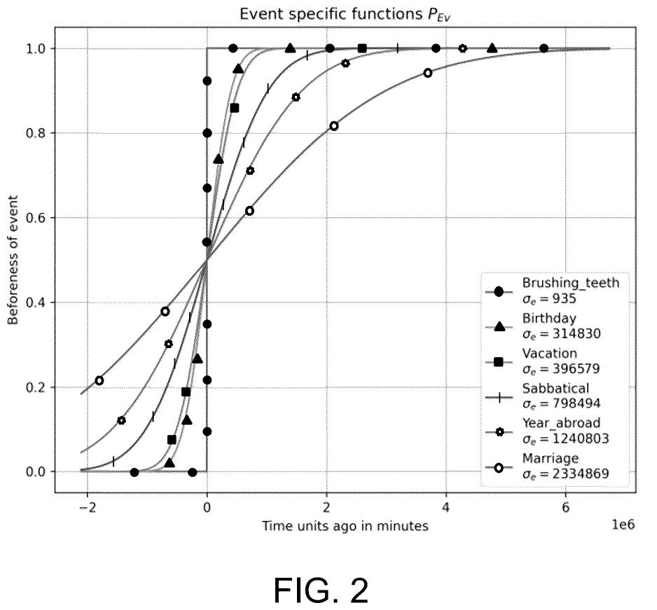

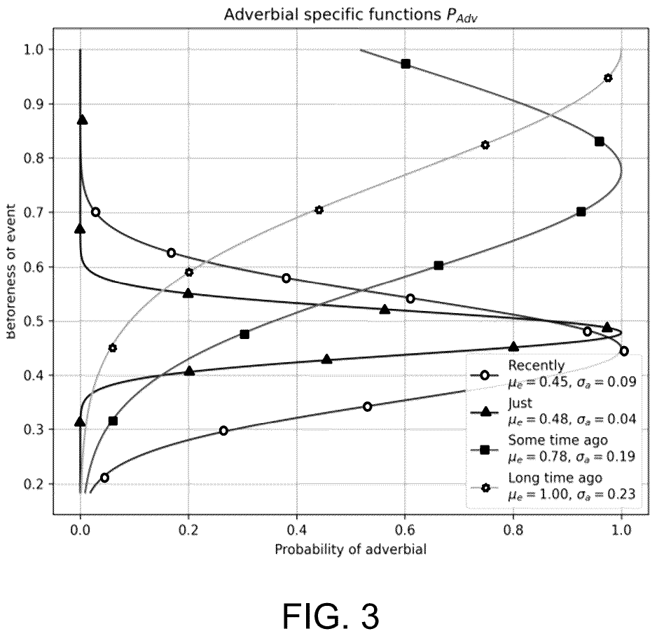

FIG. 2 shows the composition of all six event-specific functions, and FIG. 3 the four temporal expression-specific functions in the discussed example.

FIG. 2 illustrates the event-specific functions P_{Ev} for the six events of the fitted model with the parameters calculated based on the exemplary data for the six events. On the x-axis, a time since the event occurred in minutes is shown. On the y-axis, a normalized beforeness (preexistence) of the respective event is shown with values normalized in the interval between 0 and 1.

FIG. 3 illustrates the temporal-expression-specific functions P_{Adv} (adverbial-specific functions P Adv for the four temporal expressions “recently”, “just”, “some time ago”, and “long time ago” of the fitted model with the model parameters calculated based on the exemplary data as discussed before. On the x-axis, the probability of the respective temporal expressions is shown, while the y-axis shows the respective preexistence of the event.

Returning to the flowchart of FIG. 1, the method comprises a step S4 of an output interface 5 outputting the at least one quantitative time expression. The output interface 5 may output the quantitative time expression to a system for searching a database using the quantitative time expression in a query to the database. Using the quantitative time expression instead of the temporal expression enables a meaningful search of the database, which would not be possible with the temporal expression.

Before discussing a block diagram of an implementation of the system 1, the advantages of the disclosed factorized compositional model for performing the mapping from temporal expressions to quantitative time expressions are evaluated. For evaluating the compositional model P_{Adv} (P_{Ev}(t)), a baseline, a non-factorized model that relies on a single Gaussian distribution for each pair of temporal adverbial and event type is used. The factorized compositional model is compared with the non-factorized model in terms of two key aspects, the accuracy and the extendibility. The non-factorized model is a normalized Gaussian function, which has the form of expression (5)

$$exp ( - \frac{1}{2} {( \frac{( x - μ )}{σ} )}^{2} ) ; \qquad ( 5 )$$

The Gaussian for the non-factorized model may be fitted to a corresponding empirical data as the factorized compositional model, from document [Kenneweg et al, 2024], using a least square optimization or a similar approach. One difference is that each pair of a temporal expression and an event is fitted its own Gaussian, such as one for the pair including the event “vacation” and the temporal expression “recently”, and another one for the pair including the same event “vacation” with another temporal expression “some time ago”, e.g.

The first criterion is the accuracy.

Accuracy measures how closely the model's predictions align with empirical data serving as ground truth data. For the evaluation, empirical data from [Kenneweg et al. 2024] is used as the ground truth data. For evaluating the accuracy of the trained model, a probability for a temporal expression (adverbial probability) for a given elapsed time point of an event using the disclosed factorized composition model is calculated. Then an average absolute difference between the predicted value and all votes from the empirical data is determined as the average prediction error. Table 3 shows the average prediction error per event, temporal expression and over all events and temporal expression for the disclosed factorized compositional model and the normalized Gaussian as a non-factorized model:

TABLE 3

| | | Factorized | Non-factorized |
|---|---|---|---|
| Type | Name | Model | Model |
| Event | Brushing Teeth | 0.19 | 0.22 |
| | Birthday | 0.19 | 0.19 |
| | Vacation | 0.19 | 0.19 |
| | Sabbatical | 0.21 | 0.22 |
| | Year Abroad | 0.21 | 0.21 |
| | Marriage | 0.19 | 0.18 |
| Adverbial | Just | 0.16 | 0.15 |
| | Recently | 0.18 | 0.17 |
| | Some time ago | 0.28 | 0.29 |
| | Long time ago | 0.18 | 0.20 |
| Overall | | 0.20 | 0.20 |

The second criterion for the comparison is the extendibility. The extendibility is the characteristic of a system to adapt to novel scenarios or new inputs. In present circumstances, understanding the effort involved in extending the disclosed factorized compositional model to new vague temporal expressions, to new types of event, or to both is of particular interest. The dataset used to fit the parameters of the model comprises six events and four temporal expressions. For the factorized compositional model, 6+4=10 fitted functions are required to include all events and temporal expressions included in the empirical dataset. The normalized Gaussian model used as a baseline for the evaluation of the factorized compositional model, requires one function for each pair comprising one event one temporal expression, resulting in 6*4=24 fitted functions.

Expanding the factorized compositional model to include one additional event requires one additional function, yielding 7+4=11 functions in total.

The normalized Gaussian approach of the baseline model would require one additional function for each included temporal expression when adding one event, yielding 4 additional functions and 7*4=28 total fitted functions. Table 4 illustrates this scalability effect by representing the number of required functions for up to 16 events and 16 vague temporal expressions:

TABLE 4

Needed Functions

| | | |
|---|---|---|
| Number of | Factorized | Non-factorized |

| Events | Adverbials | Model | Model |
|---|---|---|---|
| 2 | 2 | 4 | 4 |
| 2 | 4 | 6 | 8 |
| 2 | 8 | 10 | 16 |
| 2 | 16 | 18 | 32 |
| 4 | 16 | 20 | 64 |
| 8 | 16 | 24 | 128 |
| 16 | 16 | 32 | 256 |

In particular, table 4 illustrates the number of needed functions for x events and y temporal expressions (adverbials) for the factorized compositional model of present disclosure and the baseline model, here the normalized Gaussian.

When discussing the evaluation of the factorized compositional model with regard to the baseline model, it is to be noted that a first step towards formally defining a reference class—the context in which a vague predicate is interpreted, has been taken. This addresses the gap existing in the prior art approaches. Previous approaches acknowledge the need for a reference class but do not provide any account or suggestion of how to conceive the reference class. The novel approach using the factorized compositional model reveals in the evaluation that each examined event has its own distinct standard deviation, as illustrated in table 1. This suggests that every event possesses a characteristic temporal signature.

The characteristic temporal signature of an event is most likely determined by its frequency and duration. When considering, e.g., the event of “brushing teeth”, table 1 shows a relatively narrow standard deviation (σₑ=935), whereas the event “sabbatical” shows a considerably larger standard deviation (σₑ=798494). These findings might indicate that the characteristic temporal signature shapes the reference class function (event function P_{Ev}). Although the empirical dataset includes only six events, the illustrated results, which match the accuracy of the baseline model as shown in table 3, suggest that the factorized compositional model effectively captures the meaning of temporal expressions.

The factorized compositional model of present disclosure is advantageous when compared to a non-factorized model as it has a similar predictive power while representing a simpler explanation of the phenomenon.

As shown by evaluating the factorized compositional model with the chosen baseline, its core advantageous characteristic is its extendibility: instead of requiring a dedicated function for each pair consisting of one temporal expression and one event, the factorized compositional model enables an approach that separates the modeling of events and temporal expressions into two distinct components. As a result, the required number of functions for the factorized compositional model increases linearly when the number of events and temporal expressions grows.

Contrary thereto, when regarding the baseline model, e.g. the normalized Gaussian model, the number of functions increases with a quadratic relationship. Table 4 reveals that, when modeling 16 events and 16 temporal expressions, the normalized Gaussian would need 16*16=256 functions, while the factorized compositional model requires 16+16=32, and therefore only about 12.5% of the normalized Gaussian model.

The percentage gets even smaller when including more temporal expressions and events: For 100 events and 100 temporal expressions, the factorized compositional model of present disclosure requires 200 functions, the normalized Gaussian model 10000 functions. In this example, therefore factorized compositional model needs only 2% of the normalized Gaussian model. Although the significant benefit in the extendibility, the accuracy of the factorized compositional model compared with the baseline approach is equal. Both models have an averaged error of 0.2 according to the evaluation as illustrated in table 3.

An inherent limitation of the factorized compositional model is in the required additional data for new temporal expressions and event types. An interesting direction for improvement is whether the generalizability of the factorized compositional model can be improved by considering equivalence classes or categories of events that share a similar duration and frequency.

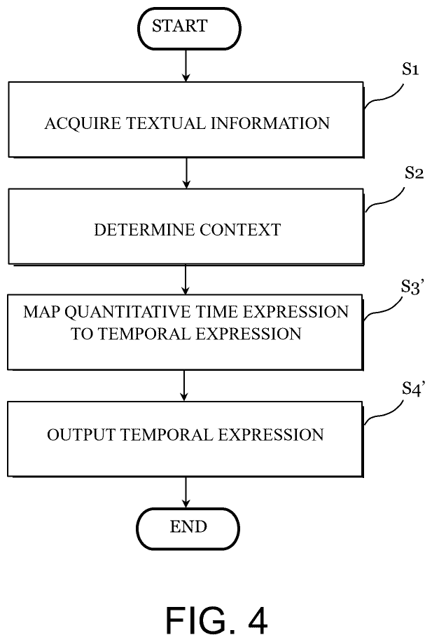

FIG. 4 shows a simplified flowchart illustrating processing steps of the computer-implemented method in an exemplary embodiment.

The method for mapping quantitative time expressions to temporal expressions is executed in a system 1 comprising a memory 2 and a processor 3 for storing information in the memory 2 and retrieving information from the memory 2.

The method comprises, in a step S1, acquiring, by an input interface 4, textual information, wherein the textual information includes at least one quantitative time expression.

In step S2, the processor 3 determines a context in the acquired textual information. The context may include a personal state of a user in the acquired textual information. The context may include a cultural framing of a user.

Based on the determined context in the acquired textual information, the processor 3 proceeds in step S3′ with mapping the at least one quantitative time expression to at least one temporal expression based on the determined context.

The processor 3 maps the quantitative time expression to the respective at least one at least one temporal expression by representing semantics of the at least one temporal expression in probabilistic distributions combining the semantics with event-specific properties.

In particular, the processor 3 maps the at least one quantitative time expression to the respective at least one temporal expression by using factorization and Gaussian distribution for modelling a context sensitive interpretation of the at least one temporal expression.

The output interface 5 outputs in step S4′ then the at least one temporal expression.

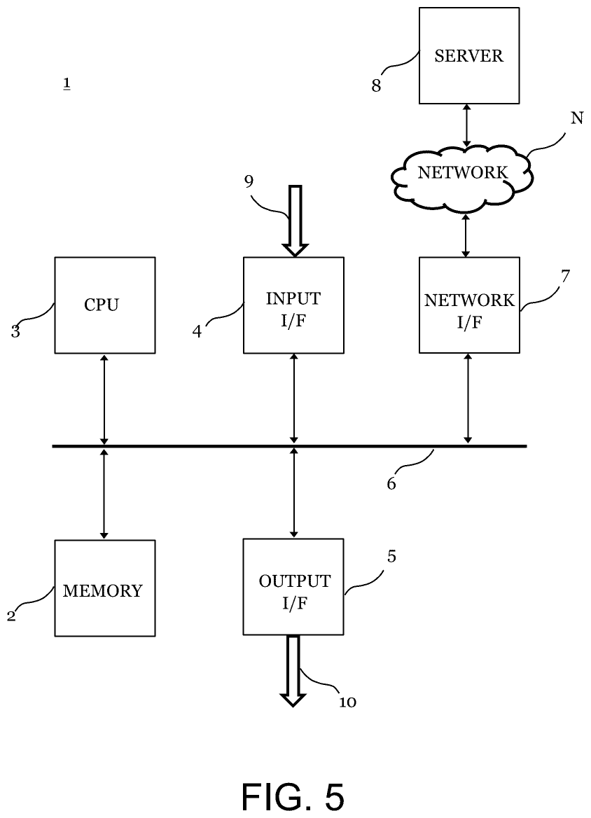

FIG. 5 shows a block diagram illustrating structural and functional elements of a system 1 for mapping temporal expressions to quantitative time expressions. FIG. 5 is a simplified overview of a hardware architecture for an implementation of the system 1 in an example.

The system 1 comprises a memory 2, and a processor 3 configured to store information and to retrieve information from the memory 2. The system 1 includes at least one bus 6 connecting the elements of the system 1, including in particular the memory 2, the processor 3, an input interface 4, and an output interface 5.

The system 1 comprises the input interface 4 that acquires input information 9. In particular the system acquires in the input information textual information, wherein the textual information includes at least one temporal expression.

In particular, the system 1 may acquire via the input interface 4, a content segment including speech or text as textual information. The content segment includes the at least one vague temporal expression, and further includes contextual information.

In a specific application of the system 1, the input interface 4 acquires a request for interpreting the content segment, in particular interpreting the content segment in relation to the at least one vague temporal expression included in the content segment.

In a specific application of the system 1, the input interface 4 acquires information on actions performed by a user. The acquired textual information including the at least one temporal expression is related to the actions.

The processor 3 is configured to determine a context in the acquired textual information, and to respectively map the at least one vague temporal expression to at least one quantitative time expression based on the determined context.

In the specific application of the system 1, the processor 3 determines based on the at least one quantitative time expression, and further based on the acquired information on the actions a response to the acquired textual information.

In the specific application of the system 1, the processor 3 determines based on the at least one quantitative time expression, and further based on the acquired information on the actions, a response to the acquired textual information. The processor 3 then provides the generated response to an output interface 5 of the system 1.

The processor 3 outputs via the output interface 5 output information 10.

In particular, the output interface 5 is configured to output the at least one quantitative time expression in the output information 10. In the specific application of the system 1, the output interface 5 outputs in the output information 10 the generated response to the user.

The system 1 comprises a network interface 7, which enables the system 1, in particular the processor 3, to access at least one database stored on a data store 8 (server 8) via the network interface 7 and a network N.

The network N includes at least one of a wired network and a wireless network, a local area network (LAN), a wide area network (WAN) and a global network, including the world wide web or internet.

The at least one database may store, e.g., training data for training a machine learning model, a trained machine learning model, and a large language model for generating a response to a query or prompt by a user.

Referring to the figures, the parameters of the factorized compositional model are fitted relying on stored data, which includes the judgments of English speakers regarding the applicability of the different vague temporal expressions to describing events that occurred a predetermined time unit away from the utterance time of the statement. For discussing the advantageous characteristics of the disclosed approach, a non-factorized approach as a baseline that models the likelihood for every pair of vague temporal expression and type of event explicitly in terms of accuracy and extendibility is used.

The disclosed factorized compositional model captures the semantics of temporal expressions (vague temporal expressions, temporal adverbials). The disclosed approach models an application of a temporal expression to an event by defining two probability density functions: P_{Adv} for the temporal expression and P_{Ev} for the event. The resulting composition P_{Adv} (P_{Ev}(t)) computes the probability that a temporal expression applies to an event that happened t time units ago. In defining P_{Ev} as the reference class for the vague temporal expression, the approach provides an initial step towards formally defining a reference class of a vague predicate. By fitting the disclosed factorized compositional model to empirical survey data, the model is instantiated for six events and four temporal expressions in the form of vague temporal adverbials.

As the evaluation demonstrates, the factorized compositional approach matches the predictive accuracy of a non-factorized baseline model while being simpler, due to having less parameters and easier to extend to new types of events and temporal expressions.

The discussed examples address a limited range of six events and four vague temporal expressions and therefore less than those encountered in everyday life and human language. Extending the factorized compositional model to additional events and adverbials requires only defining one function for each additional event or temporal expressions.

All steps which are performed by the various entities described in the present disclosure as well as the functionalities described to be performed by the various entities are intended to mean that the respective entity is adapted to or configured to perform the respective steps and functionalities.

In the claims as well as in the description the word “comprising” does not exclude the presence of other elements or steps.

The indefinite article “a” or “an” does not exclude a plurality.

A single element or other unit may fulfill the functions of several entities or items recited in the claims. The mere fact that different dependent claims recite certain measures and features of the control circuit does not exclude that a combination of these measures and features cannot combined in an advantageous implementation.

The features described in the discussion of specific embodiments and depicted in the figures may be combined with each other for the invention defined in the attached claims.

What is claimed is:

1. A system for mapping temporal expressions to quantitative time expressions, the system comprising:
a memory;
a processor configured to store information and to retrieve information from the memory;
an input interface configured to acquire textual information, wherein the textual information includes at least one temporal expression;
wherein the processor is configured to determine a context in the acquired textual information, to respectively map the at least one temporal expression to at least one quantitative time expression based on the determined context; and
an output interface configured to output the at least one quantitative time expression.

2. The system according to claim 1, wherein
the processor is configured to determine the context including at least one of a duration and a frequency of an event in the acquired textual information.

3. The system according to claim 1, wherein
the processor is configured to determine the context including a personal state of a user in the acquired textual information.

4. The system according to claim 1, wherein
the processor is configured to determine the context including a cultural framing of a user.

5. The system according to claim 1, wherein
the quantitative time expression includes at least one of an absolute time and an absolute date.

6. The system according to claim 1, wherein
the at least one time expression comprises a temporal adverbial, including, for example, one of “recently”, “just”, “some time ago”, “long time ago”.

7. The system according to claim 1, wherein
the processor is configured to map the at least one temporal expression to the respective at least one quantitative time expression by representing semantics of the at least one temporal expression in probabilistic distributions combining the semantics with event-specific properties.

8. The system according to claim 1, wherein
the processor is configured to map the at least one temporal expression to the respective at least one quantitative time expression by using factorization and Gaussian distribution for modelling a context sensitive interpretation of the at least one temporal expression.

9. The system according to claim 1, wherein
the input interface is configured to acquire information on actions performed by a user,
wherein the acquired textual information including the at least one temporal expression is related to the actions; and
the processor is configured to determine, based on the at least one quantitative time expression and the acquired information on the actions of the user, a response to the acquired textual information.

10. A system for mapping quantitative time expressions to temporal expressions, the system comprising:
a memory;
a processor configured to store information and to retrieve information from the memory;
an input interface configured to acquire textual information, wherein the textual information includes at least one quantitative time expression;
wherein the processor is configured to determine a context in the acquired textual information, to respectively map the at least one quantitative time expression to at least one temporal expression based on the determined context; and
an output interface configured to output the one temporal expression.

11. A method for mapping temporal expressions to quantitative time expressions in a system comprising a memory and a processor for storing information in and retrieving information from the memory, the method comprising:
acquiring, by an input interface, textual information, wherein the textual information includes at least one temporal expression;
determining, by the processor, a context in the acquired textual information;
mapping, by the processor, the at least one temporal expression to at least one quantitative time expression based on the determined context; and
outputting, by an output interface, the at least one quantitative time expression.

12. A method for mapping quantitative time expressions to temporal expressions in a system comprising a memory and a processor for storing information in and retrieving information from the memory, the method comprising:
acquiring, by an input interface, textual information, wherein the textual information includes at least one quantitative time expression;
determining, by the processor, a context in the acquired textual information;
mapping, by the processor, the at least one quantitative time expression to at least one temporal expression based on the determined context; and
outputting, by an output interface, the at least one temporal expression.

13. A non-transitory computer readable medium storing a computer program comprising instructions, which, when a processor executes the computer program, causes the processor to perform the method of claim 11.

14. A non-transitory computer readable medium storing a computer program comprising instructions, which, when a processor executes the computer program, causes the processor to perform the method of claim 12.
